(19) United States
(12) Patent Application Publication
(10) Pub. No.: US 2025/0165690 A1
(43) Pub. Date: May 22, 2025

(54) UNDER TEST (DUT) PROCESSING FOR LOGIC OPTIMIZATION

(71) Applicant: Synopsys, Inc., Sunnyvale, CA (US)

(72) Inventors: Mu-Ting Wu, Hsinchu (TW); Tzu-Chien Hsu, Hsinchu (TW); Yu-Hsuan Su, Hsinchu (TW); Sabyasachi Das, San Jose, CA (US)

(21) Appl. No.: 18/518,225

(22) Filed: Nov. 22, 2023

(51) Int. Cl. G06F 30/337; G06F 30/333; G06F 119/12

(52) U.S. Cl. CPC G06F 30/337; G06F 30/333; G06F 2119/12

(57) ABSTRACT

An example is a non-transitory computer-readable storage medium including stored instructions. The instruction, which when executed by one or more processors, cause the one or more processors to: obtain a representation of a design under test (DUT) and split the representation of the DUT into multiple partitions. The representation of the DUT includes optimizable leaf instances and timing paths between respective timing startpoints and timing endpoints. Splitting the representation of the DUT into multiple partitions is based on respective slacks of the timing endpoints. Each partition of the multiple partitions includes one or more timing endpoints of the timing endpoints and a transitive fan-in including one or more optimizable leaf instances along one or more timing paths of the timing paths that terminate at the respective one or more timing endpoints.

### TECHNICAL FIELD

The present disclosure generally relates to emulation or hardware prototyping for verifying a circuit design. In particular, the present disclosure relates to design under test (DUT) processing for logic optimization for emulation or hardware prototyping.

### BACKGROUND

Designing a circuit may be an arduous process, particularly for today's complex System-on-Chip (SoC) circuits. The design is commonly thoroughly tested to ensure functionality, specifications, and reliability. The design may also be iteratively re-designed to meet target functionality, specifications, and reliability. The importance of these tests and re-design prior to tape out and fabrication is significant as the costs and complexity of tape out and fabrication is substantial.

### SUMMARY

An example is a non-transitory computer-readable storage medium including stored instructions. The instruction, which when executed by one or more processors, cause the one or more processors to: obtain a representation of a design under test (DUT) and split the representation of the DUT into multiple partitions. The representation of the DUT includes optimizable leaf instances and timing paths between respective timing startpoints and timing endpoints. Splitting the representation of the DUT into multiple partitions is based on respective slacks of the timing endpoints. Each partition of the multiple partitions includes one or more timing endpoints of the timing endpoints and a transitive fan-in including one or more optimizable leaf instances along one or more timing paths of the timing paths that terminate at the respective one or more timing endpoints.

Another example is a system that includes a memory and a processing device. The memory stores instructions. The processing device is coupled with the memory and is to execute the instructions. The instructions when executed cause the processing device to: obtain a representation of a DUT including multiple partitions; determine, for each partition of the multiple partitions, whether the respective partition includes a first optimizable leaf instance that drives a second optimizable leaf instance; and mark the respective partition for logic optimization based on a determination that the respective partition includes a first optimizable leaf instance that drives a second optimizable leaf instance.

A further example is a method. A representation of a DUT is obtained. An anchor circuit instance is inserted, by a processing device, into the representation of the DUT and is connected to a timing path between a first port of an optimizable leaf instance and a second port of a circuit instance. The first port includes protected information. The protected information of the first port is mapped to an anchor port of the anchor circuit instance.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is an emulation and/or prototyping environment for functional verification according to some examples.

FIG. 2 is a flowchart of a method of partition splitting with timing consideration according to some examples.

FIG. 3 is a block schematic of a partition of a representation of a design under test (DUT) according to some examples.

FIG. 4 is a flowchart of a method for including and excluding partitions for analysis in a logic optimization technique according to some examples.

FIGS. 5 and 6 are block schematics of respective partitions according to some examples.

FIG. 7 is a flowchart of a method for maintaining protected information in a representation of a DUT according to some examples.

FIG. 8 is a portion of a representation of a DUT according to some examples.

FIG. 9 is the portion of the representation of the DUT of FIG. 8 with an anchor circuit instance inserted according to some examples.

FIG. 10 is a portion of a representation of a DUT according to some examples.

FIG. 11 is the portion of the representation of the DUT of FIG. 10 with an anchor circuit instance inserted according to some examples.

FIG. 12 is the portion of the representation of the DUT of FIG. 10 with an anchor circuit instance inserted according to some examples.

FIG. 13 is a flowchart of a method for processing a DUT for mapping to an emulation and/or prototyping system according to some examples.

FIG. 14 depicts a flowchart of various processes used during the design and manufacture of an integrated circuit in accordance with some examples.

FIG. 15 depicts a diagram of an example emulation system in accordance with some examples.

FIG. 16 depicts a diagram of an example computer system in which examples may operate.

### DETAILED DESCRIPTION

Aspects of the present disclosure relate to design under test (DUT) processing for logic optimization for emulation or hardware prototyping. The present disclosure includes splitting partitions of the representation of the DUT, excluding trivial partitions of the representation of the DUT from a logic optimization technique, and inserting anchor circuit instances for remapping protected information from a port in the representation of the DUT.

Functional verification of a DUT may include emulating or prototyping the DUT on an emulation or hardware prototyping system. An emulation or hardware prototyping system may include one or more field programmable gate arrays (FPGAs) on which a representation of the DUT is instantiated for the functional verification. A representation of a DUT may undergo synthesis, resynthesis, and compilation to obtain a representation of a DUT that may be instantiated on one or more FPGAs (e.g., as a bitstream). For example, a hardware description language (HDL) representation (e.g., register transfer language (RTL)) of a DUT may be synthesized into an FPGA netlist, which may be further resynthesized into another (e.g., optimized) FPGA netlist. The resynthesized FPGA netlist may then be compiled into an executable file (e.g., a bitstream) that may be instantiated on the one or more FPGAs.

A representation of a DUT on which synthesis is performed may be partitioned based on a hierarchy of modules within the DUT (e.g., each partition includes instances of a same hierarchical level). Since a hierarchical strategy may be adopted during synthesis, the resulting netlist may be sub-optimal in terms of area and timing. Furthermore, the synthesizer rarely spends great efforts on optimizing path delay and often generates long logical paths. To improve critical path delay, resynthesis may be performed on an FPGA netlist using a logic optimization tool.

A generic logic optimization tool may be powerful. However, there are several problems with resynthesis using a generic logic optimization tool. First, a generic logic optimization tool may not support a hierarchical netlist. Second, performing a logic optimization technique on a fully flattened netlist may be infeasible due to large DUTs and resulting long runtimes. Hierarchies are usually treated as partitions, and a logic optimization technique may be performed using parallel multithreading on the partitions. However, any potential solution is bounded by partitions, and the solution may be sub-optimal. The logic optimization tool will have trouble synchronizing timing information between different partitions. For example, if a long path goes through different partitions, in both partitions this path will be treated as two short paths, which is misleading for the logic optimization tool. Furthermore, performing a logic optimization technique on a large partition containing a large number of optimizable instances may take a long runtime and may limit the throughput for netlist resynthesis. Additionally, some partitions may not contribute to a solution for resynthesis, and hence, computing resources of the logic optimization tool and time are wasted on these partitions. Further, in many DUTs, some design attributes must be preserved, which may lead to sub-optimal solutions generated by the logic optimization tool.

Technical advantages of some examples of the present disclosure include, but are not limited to, improving both the emulation or hardware prototyping system performance and resynthesis and compilation time. Such examples include splitting partitions into smaller sub-partitions based on timing path considerations. Critical paths of a partition (which partition may be flattened to, e.g., optimizable leaf instances or optimizable circuit cells) may be gathered into a smaller sub-partition such that a logic optimization technique may optimize the critical paths, while the sub-partitions remain sufficiently small to not grow or to reduce the overhead for compilation time. The logic optimization technique may be performed on the sub-partitions by processing the sub-partitions in parallel, multiple threads, which may accelerate resynthesis. By keeping critical paths in respective sub-partitions, a critical path delay may be reduced by a logic optimization technique so that an emulator may operate on a faster clock frequency. Accordingly, resynthesis and compilation time may be reduced, while improving emulator performance by a faster clock frequency.

Additionally, technical advantages of some examples of the present disclosure include, but are not limited to, accelerating resynthesis by exclusion of trivial partitions. Commonly, a representation of a DUT may include many partitions. Some of these partitions may not significantly affect the solution of the logic optimization technique while causing a significant amount of computing resources to be consumed by the logic optimization technique. Accordingly, some examples exclude such trivial partitions from being analyzed by the logic optimization technique, which permits runtime of resynthesis to be reduced.

Further, technical advantages of some examples of the present disclosure include, but are not limited to, improved solutions of a logic optimization technique while maintaining protected information in a representation of a DUT. For many DUTs, the DUT will include design information that is to be preserved and protected, such as for debugging. This protected information may include false path information and waveform observation point information. Accordingly, some examples include inserting an anchor circuit instance in the representation of the DUT connected to a port that has protected information and mapping that protected information to an anchor port of the anchor circuit instance. The logic instance (e.g., optimizable leaf instance) that has the port may therefore be exposed to the logic optimization technique (rather than be treated as a black box that may not be optimized), which may result in an improved solution of the logic optimization technique while the protected information is maintained at the anchor port.

Various combinations of the above generally recited examples may be implemented according to various other examples. Hence, various other examples may achieve any of the above technical advantages. Other advantages and benefits may be achieved by examples.

Various algorithms or techniques described herein may be referred to as optimization algorithms or optimization technique. The terminology “optimization algorithm” and “optimization technique” is to be understood as used in the relevant art and does not require a result of the optimization algorithm or technique to be an absolute best or most optimal result. Rather, an optimization algorithm or technique may generally determine a result, e.g., that is at or near a local minimum or maximum of a mathematical space based on some predefined criteria or characteristics. For example, a result of an optimization algorithm may be based on reaching a gradient in the mathematical space that is less than a predefined threshold, which result may not be at a local minimum or maximum but may be near the local minimum or maximum. Any tool or other device that is modified by “optimize” or “optimization” may, as context dictates, refer to a tool or device that performs, in whole or in part, an optimization algorithm or optimization technique.

Various modification may be made to examples described herein. For example, any methodology described herein may be performed in any logical order. Such modifications may implement a same or similar functionality and may achieve advantages and benefits described above. Further, although some examples may be described in the context of resynthesis or another context, examples described herein may be implemented for processing (e.g., preprocessing) a DUT for a logic optimization technique regardless of the context or purpose of the logic optimization technique.

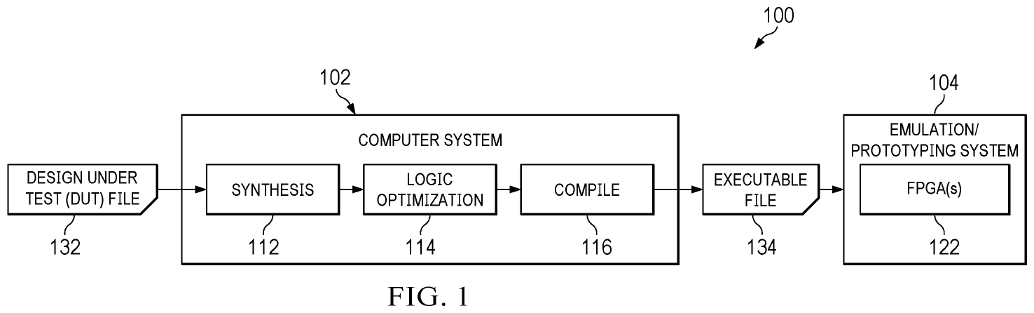

FIG. 1 is an emulation and/or hardware prototyping environment 100 (“emulation/prototyping environment 100”) for functional verification according to some examples. The emulation/prototyping environment 100 includes a computer system 102 and an emulation and/or hardware prototyping system 104 (“emulation/prototyping system 104”). An example computer system 102 and an example emulation system are described in detail subsequently. A hardware prototyping system may be the same as or similar to the emulation system subsequently described. The computer system 102 includes a synthesis tool 112, a logic optimization tool 114, and a compile tool 116. Each of the synthesis tool 112, logic optimization tool 114, and compile tool 116 operates on the computer system 102. The synthesis tool 112, logic optimization tool 114, and compile tool 116 are illustrated as operating on a same computer system 102. However, in other examples, one or more of the synthesis tool 112, logic optimization tool 114, and compile tool 116 may operate on different computer systems or any permutation between operating on a same computer system and on different computer systems. Further, each of the synthesis tool 112, logic optimization tool 114, and compile tool 116 may be distributed across multiple computer systems. When the various tools are distributed, some computer systems may be located remotely from others on which another tool is operating. For example, the synthesis tool 112 may operate on multiple computer systems (e.g., at a data processing farm). Similarly, the logic optimization tool 114 may operate on multiple computer systems (e.g., at a data processing farm). Multiple computer systems implementing one or more logic optimization tools 114 may implement multiple parallel threads. The emulation/prototyping system 104 includes one or more field programmable gate arrays (FPGAs) 122.

The synthesis tool 112, logic optimization tool 114, and compile tool 116 may each be embodied as instructions stored on a non-transitory computer-readable storage medium (e.g., memory, such as random access memory (RAM), read only memory (ROM), etc.). The instructions, when executed by one or more processors (e.g., of the computer system 102), cause the one or more processors to carry out the various functionality of the respective tool as described herein.

The synthesis tool 112 receives a design under test (DUT) file 132. The DUT file 132 includes a representation of a circuit that is to be tested prior to manufacturing the circuit. The DUT file 132 may be or include a representation of the circuit, such as including a hardware description language (HDL) representation, a register transfer language (RTL), a circuit schematic, or the like. The synthesis tool 112 is configured to and is operable to receive or obtain the DUT file 132 and perform a synthesis operation on the DUT file 132 to generate a preliminary netlist corresponding to the representation of the circuit.

The logic optimization tool 114 receives the preliminary netlist. The logic optimization tool 114 is configured to and operable to perform one or more of the methodologies described subsequently and to perform a logic optimization technique on the preliminary netlist to obtain an optimized netlist. The compile tool 116 receives the optimized netlist. The compile tool 116 is configured to and operable to compile the optimized netlist and generate a corresponding executable file 134 that may be executed by the FPGA(s) 122 of the emulation/prototyping system 104. The executable file 134 may include or be, for example, a bitstream file. The emulation/prototyping system 104 receives the executable file 134 from the computer system 102 (e.g., by a direction connection, via a network, and/or via a storage system, like a database). The emulation/prototyping system 104 loads the executable file 134 onto the FPGA(s) 122 for functional verification.

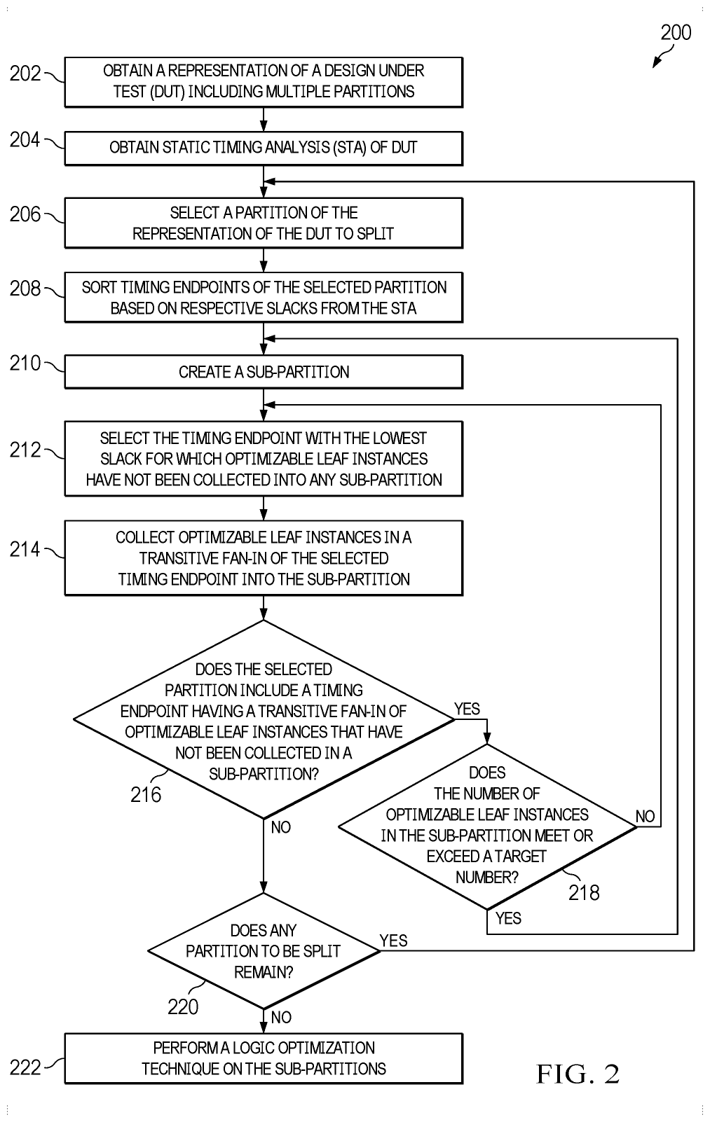

FIG. 2 is a flowchart of a method 200 of partition splitting with timing consideration according to some examples. As described herein, the method 200 may be performed in the context of a representation of a DUT (e.g., a preliminary netlist) that includes multiple partitions. The method 200 may iterate over the multiple partitions and further split the partitions into respective sub-partitions. The method 200 of FIG. 2 may be particularly beneficial for splitting extremely large partitions but may be applied to any partition of a DUT. In other examples, the representation of the DUT may not include multiple partitions, and in such examples, the method 200 may be performed by treating the representation of the DUT as a single partition to be split. In the method 200, a partition is described as being split into sub-partitions solely for clarity of description; however, a sub-partition may be considered as simply a partition.

At 202, a representation of a DUT including multiple partitions is obtained. The representation of the DUT, and partitions thereof, may be or include a netlist, such as an FPGA netlist, that is generated from a synthesis operation. In some examples, a partition may include a number of optimizable leaf instances, and a mega-partition may be a partition that includes more than a number (e.g., a predetermined number) of optimizable leaf instances. According to some examples, an optimizable leaf instance is a minimum unit of a circuit component that may be analyzed by a logic optimization technique. In some examples, a logic optimization technique may optimize combinational logic, and in some examples, a logic optimization technique may optimize both combination logic and sequential logic (e.g., including synchronous elements). In some examples where emulation or prototyping is performed on FPGA(s), which is look-up table (LUT) based, an optimizable leaf instance may be or include an LUT.

In some examples, one or more of the partitions of the representation of the DUT include a hierarchy of circuit modules, and in such examples, the method 200 may include flattening each such partition to a level of the optimizable leaf instances. Any given circuit module may include sub-modules. A module or sub-module may include one or more optimizable leaf instances. Flattening a partition includes replacing a circuit module (which may be a level of representation in the partition) with the one or more optimizable leaf instances and/or non-optimizable circuit instances, with the respective connections therebetween, that the respective circuit module represents. Flattening the representation of the DUT may gather each optimizable leaf instance on respective timing paths to a same hierarchical level, which may lead to a higher quality logic optimization result. Any methodology described herein that operates on one or more optimizable leaf instances may include flattening the representation of the DUT (or partition(s) or sub-partition(s) thereof) to a level of the optimizable leaf instances.

At 204, a static timing analysis (STA) of the DUT is obtained. The static timing analysis may be performed during synthesis, as part of the method 200 of FIG. 2, or by some other operation. The STA includes slack of each timing path in the DUT, where a timing path is from a timing startpoint to a timing endpoint. Any combinational logic network may have any number of timing paths through that combinational logic network. A timing startpoint may be an input port of the partition or the DUT (e.g., if the DUT is not partitioned) or an output port of a synchronous element (e.g., a flip-flop) in the partition. A timing endpoint may be an output port of the partition or the DUT (e.g., if the DUT is not partitioned) or an input port of a synchronous element in the partition. A synchronous element may terminate a timing path and be the beginning of another timing path. In some examples, a timing path may include a synchronous element that includes the respective timing startpoint or timing endpoint, while in other examples, the synchronous element that includes the respective timing startpoint or timing endpoint may not be included in the timing path. Whether the synchronous element is included in the timing path may depend on the logic optimization technique being implemented.

At 206, a partition of the representation of the DUT to split is selected. As indicated by the following description, the method 200 iterates over each partition of the representation of the DUT that is to be split. The methodology for selecting a partition for an iteration may be based on any criteria.

At 208, the timing endpoints of the selected partition are sorted based on the respective slacks from the STA. In some examples, the timing endpoints of the selected partition are sorted in an increasing order of slack. A timing endpoint may be an endpoint for multiple timing paths. When a timing endpoint is an endpoint for multiple timing paths, the smallest slack of those multiple timing paths is attributed to that timing endpoint for sorting purposes. The smallest slack of multiple timing paths that terminate at a timing endpoint is used for sorting purposes for that timing endpoint.

At 210, a sub-partition is created. A sub-partition is an organizational structure in which optimizable leaf instances are collected. Although a sub-partition is described as being created at 210, this may, in some examples, be merely for clarity of description, and in some examples, a sub-partition may be created simultaneously with collecting optimizable leaf instances in the sub-partition.

At 212, the timing endpoint of the selected partition with a desired slack (e.g., the lowest slack) (for which optimizable leaf instances have not been collected into any sub-partition) is selected. At 214, optimizable leaf instances in a transitive fan-in of the selected timing endpoint are collected into the sub-partition. The transitive fan-in includes each timing path that terminates at the selected timing endpoint. At 216, whether the selected partition includes a timing endpoint having a transitive fan-in of optimizable leaf instances that have not been collected in a sub-partition is determined. If the selected partition includes such a timing endpoint as determined in 216, at 218, a determination of whether the number of optimizable leaf instances in the sub-partition meets or exceeds a target number is determined. If not, as determined at 218, the method 200 iterates back to 212 to select another timing endpoint having the next lowest slack. If, as determined at 218, the number of optimizable leaf instances in the sub-partition meets or exceeds the target number, then, the method 200 iterates back to 210 to create another sub-partition in which optimizable leaf instances are collected.

If, as determined at 216, the selected partition does not include a timing endpoint having a transitive fan-in of optimizable leaf instances that have not been collected in a sub-partition, then, at 220, whether another partition to be split remains is determined. If so, the method 200 iterates back to 206 to select another partition, and if not, at 222, a logic optimization technique is performed on the sub-partitions. The determinations at 216 and 218 may be performed in other orders. For example, the determination of 218 may be made before 216, and each branch from 218 may subsequently include a determination of 216. The iteration from 220 to 206 in the illustrated example is for analyzing multiple partitions. In some examples, the partitions may be analyzed in parallel instead of and/or in addition to iteratively.

The logic optimization technique of 222 may be or include logic rewriting, logic rebalancing, logic refactoring, or the like. The logic optimization technique may produce respective optimized partitions or optimized sub-partitions, or may produce an optimized representation of the DUT including the optimized partitions or sub-partitions. The optimized partitions, sub-partitions, and/or representation of the DUT may be or include a netlist, such as an FPGA netlist.

The logic optimization technique may be performed in multiple, parallel threads on the respective sub-partitions. By parallelizing the logic optimization technique, the logic optimization technique may be performed in less time, which may increase resynthesis throughput. Additionally, by splitting a partition, the resulting sub-partitions may have fewer optimizable leaf instances (e.g., the respective sizes of the sub-partitions are smaller than the size of the partition). Fewer optimizable leaf instances in a sub-partition may result in faster performance of the logic optimization technique.

Further, by sorting the timing endpoints based on slack and collecting, in a sub-partition, optimizable leaf instances in the timing path(s) that terminate at the respective timing endpoints, timing paths with lower slacks may be better analyzed during a logic optimization technique. Timing paths may be maintained in the sub-partitions. The logic optimization technique may reduce the arrival time of lower slack timing paths so that an emulator may, in some cases, operate on a higher clock frequency, thereby decreasing an emulation job time and increasing emulation throughput. By implementing a timing-driven technique to split a partition into sub-partitions, any negative performance impact in emulation caused by performing a logic optimization technique with a reduced solution space (e.g., due to the smaller sub-partitions) may be alleviated.

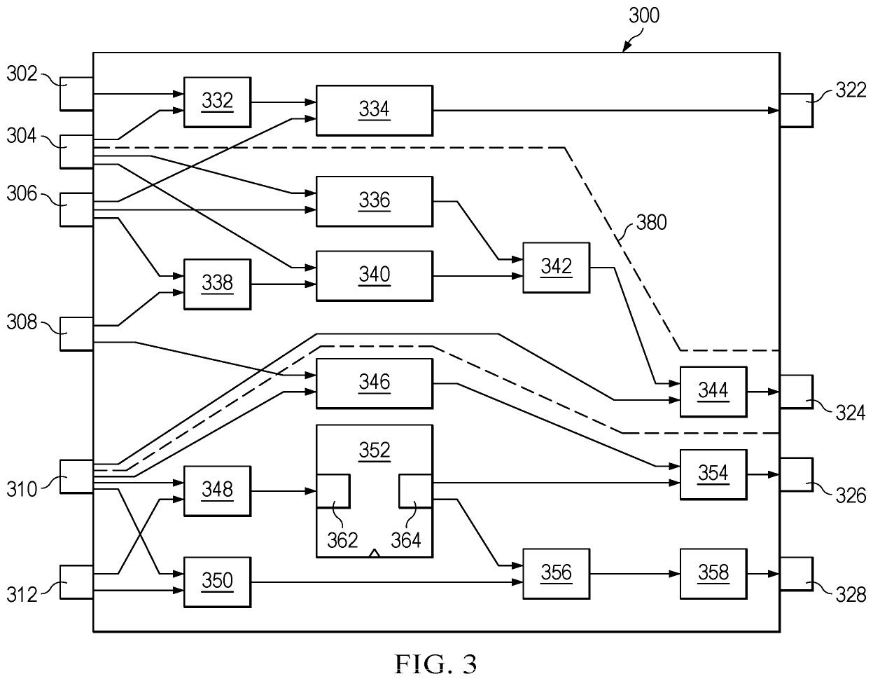

FIG. 3 is a block schematic of a partition 300 according to some examples. The partition 300 is described to illustrate some operation of the method 200 of FIG. 2. The partition 300 has partition input ports 302, 304, 306, 308, 310, 312 and partition output ports 322, 324, 326, 328. The partition 300 includes optimizable leaf instances 332, 334, 336, 338, 340, 342, 344, 346, 348, 350, 354, 356, 358 and a synchronous element 352. The synchronous element 352 has an input port 362 and an output port 364.

Table 1 below outlines, as an example, the timing paths in the partition 300 with corresponding slacks obtained from an STA.

TABLE 1

| Timing | Timing | Optimizable leaf | Timing | | |
|---|---|---|---|---|---|
| Path | Startpoint | instances | Endpoint | Slack | |
| 2-A | 302 | 332, 334 | 322 | 27 | ns |
| 2-B | 304 | 332, 334 | 322 | 23 | ns |
| 2-C | 306 | 334 | 322 | 26 | ns |
| 4-A | 304 | 336, 342, 344 | 324 | 33 | ns |
| 4-B | 304 | 340, 342, 344 | 324 | 33 | ns |
| 4-C | 306 | 336, 342, 344 | 324 | 31 | ns |
| 4-D | 306 | 338, 340, 342, 344 | 324 | 16 | ns |
| 4-E | 308 | 338, 340, 342, 344 | 324 | 2 | ns |
| 4-F | 310 | 344 | 324 | 50 | ns |
| 6-A | 308 | 346, 354 | 326 | 6 | ns |
| 6-B | 310 | 346, 354 | 326 | 39 | ns |
| 6-C | 364 | 354 | 326 | 30 | ns |
| 8-A | 310 | 350, 356, 358 | 328 | 27 | ns |
| 8-B | 312 | 350, 356, 358 | 328 | 27 | ns |
| 8-C | 364 | 356, 358 | 328 | 18 | ns |
| 10-A | 310 | 348 | 362 | 50 | ns |
| 10-B | 312 | 348 | 362 | 50 | ns |

As shown, the partition 300 includes thirteen optimizable leaf instances. In this example, the partition 300 is to be split into sub-partitions, where the target number of optimizable leaf instances for each sub-partition to include is at least seven (e.g., the target number at 218 is seven). Hence, as described below, the partition 300 is split into two sub-partitions as a result of the method 200.

Table 2 below shows the smallest slacks for respective timing endpoints of the partition 300 that are sorted in increasing amount per 208 of the method 200 of FIG. 2.

TABLE 2

| Timing Endpoint | Slack | |
|---|---|---|
| 324 | 2 | ns |
| 326 | 6 | ns |
| 328 | 18 | ns |
| 322 | 23 | ns |
| 362 | 50 | ns |

Hence, in a first iteration at 212, the partition output port 324 (e.g., a timing endpoint) is selected, and the optimizable leaf instances 336, 338, 340, 342, 344, which are in the transitive fan-in of the partition output port 324 (as generally indicated by dashed cone 380), are collected into a first sub-partition at 214. Then, at 216, the partition is determined to include additional timing endpoints, and at 218, the number of optimizable leaf instances collected in the first sub-partition is determined to be five, which is less than the target number of seven. The method 200 iterates back to 212. In this second iteration at 212, the timing endpoint with the lowest slack for which optimizable leaf instances have not been collected into any sub-partition is the partition output port 326. The optimizable leaf instances 346, 354, which are in the transitive fan-in of the partition output port 326, are collected into the first sub-partition at 214. In the described example, the logic optimization technique does not optimize a synchronous element such that the synchronous element 352 is not collected into the first sub-partition. In other examples, the logic optimization technique may optimize a synchronous element, and in such examples, the synchronous element 352 may be collected into the first sub-partition at 214. Then, at 216, the partition is determined to include additional timing endpoints, and at 218, the number of optimizable leaf instances collected in the first sub-partition is determined to be seven, which is equal to the target number of seven.

The method 200 iterates to 210 to create an additional sub-partition. Subsequently, the method 200 iterates through the remaining timing endpoints at 212 and collects the corresponding optimizable leaf instances in a second sub-partition at 214 until no timing endpoint having a transitive fan-in of optimizable leaf instances that have not been collected in any sub-partition remains in the partition, as determined at 216. The second sub-partition includes the optimizable leaf instances 332, 334, 348, 350, 356, 358. The method 200 may thereafter iterate further for additional partitions.

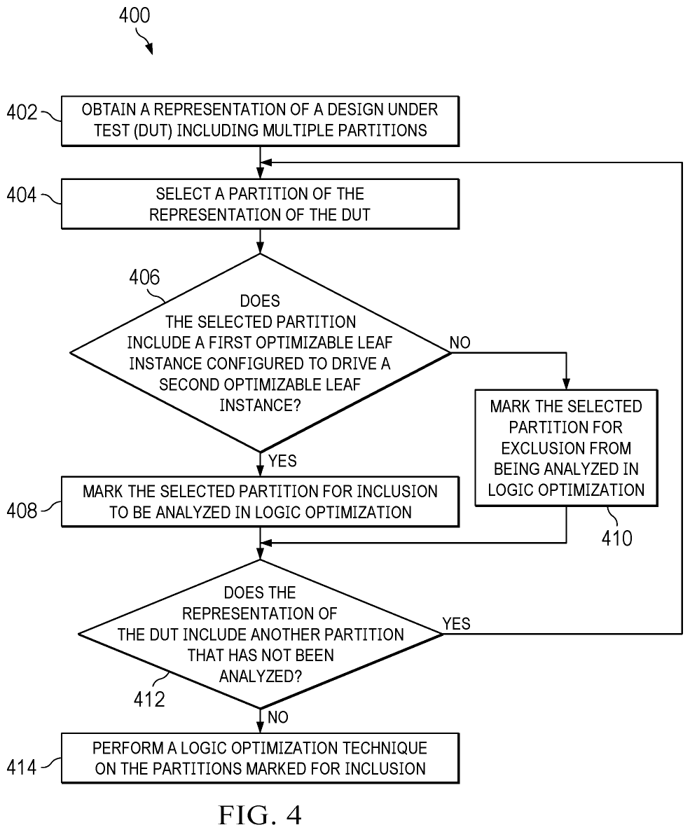

FIG. 4 is a flowchart of a method 400 for including and excluding partitions for analysis in a logic optimization technique according to some examples. Partitions that may be excluded may be considered trivial partitions. At 402, a representation of a DUT including multiple partitions is obtained. The representation of the DUT may be or include a netlist, such as an FPGA netlist, that is generated from a synthesis operation. The partitions may be sub-partitions created by the method 200 of FIG. 2 in some examples.

At 404, a partition of the representation of the DUT is selected. As indicated by the following description, the method 400 iterates over each partition (or sub-partition) of the representation of the DUT. The methodology for selecting a partition for an iteration may be based on any criteria. At 406, whether the selected partition includes a first optimizable leaf instance that is configured to drive a second optimizable leaf instance is determined. The determination of 406 may be performed by iterating over the timing paths of the selected partition until a first optimizable leaf instance configured to drive a second optimizable leaf instance is identified or all timing paths of the selected partition have been exhausted without identifying a first optimizable leaf instance that is configured to drive a second optimizable leaf instance. In some examples, the transitive fan-in of the timing endpoints may be iterated over until a first optimizable leaf instance that is configured to drive a second optimizable leaf instance is identified or all timing endpoints of the selected partition have been exhausted without identifying a first optimizable leaf instance that is configured to drive a second optimizable leaf instance.

If the selected partition includes a first optimizable leaf instance that is configured to drive a second optimizable leaf instance as determined at 406, then at 408, the selected partition is marked for inclusion to be analyzed in a logic optimization technique. If the selected partition does not include a first optimizable leaf instance that is configured to drive a second optimizable leaf instance as determined at 406, then at 410, the selected partition is marked for exclusion from being analyzed in the logic optimization technique. Following 408 and 410, whether the representation of the DUT includes another partition that has not been analyzed is determined at 412. If so, the method 400 iterates back to 404 to select another partition. If not, at 414, a logic optimization technique is performed on the partitions marked for inclusion to be analyzed by the logic optimization technique. The logic optimization technique may be or include logic rewriting, logic rebalancing, logic refactoring, or the like. The logic optimization technique may produce respective optimized partitions corresponding to the partitions that were analyzed (e.g., marked for inclusion), or may produce an optimized representation of the DUT including the optimized partitions. The optimized partitions and/or representation of the DUT may be or include a netlist, such as an FPGA netlist.

The method 400 of FIG. 4 may permit decreased time for the logic optimization technique. A partition that does not include a first optimizable leaf instance that is configured to drive a second optimizable leaf instance may have little to no impact on the solution space available for the logic optimization technique, and hence, such a partition may be considered a trivial partition. Performing a logic optimization technique on a trivial partition would take computing resources and time with little to no benefit to the resulting solution and subsequent emulator performance. By excluding a trivial partition from the logic optimization technique, computing resource may be saved, and time of the logic optimization technique may be reduced, with little to no adverse impact on the result of the logic optimization technique and subsequent emulator performance.

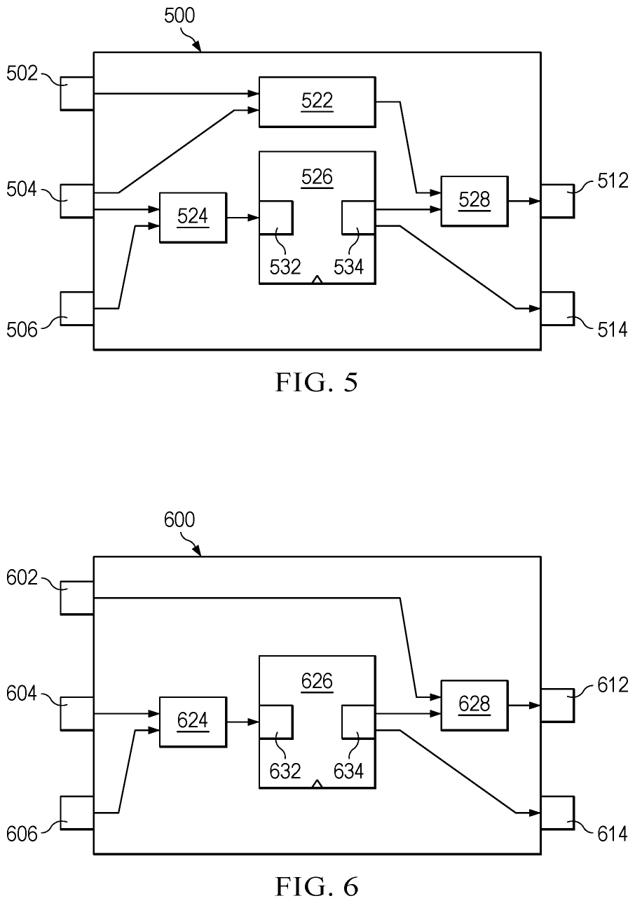

FIGS. 5 and 6 are block schematics of respective partitions 500, 600 according to some examples. The partition 500 of FIG. 5 includes a first optimizable leaf instance that is configured to drive a second optimizable leaf instance, and the partition 600 of FIG. 6 does not include a first optimizable leaf instance that is configured to drive a second optimizable leaf instance.

The partition 500 of FIG. 5 includes partition input ports 502, 504, 506, partition output ports 512, 514, optimizable leaf instances 522, 524, 528, and a synchronous element 526. The synchronous element 526 has an input port 532 and an output port 534. To determine whether the partition 500 includes a first optimizable leaf instance that is configured to drive a second optimizable leaf instance, the transitive fan-in of the partition output port 512 (e.g., a timing endpoint) may be traversed, where the optimizable leaf instance 522 that is configured to drive the optimizable leaf instance 528 is found. Hence, the partition 500 may be marked for inclusion for analysis in a logic optimization technique per the method 400 of FIG. 4.

The partition 600 of FIG. 6 includes partition input ports 602, 604, 606, partition output ports 612, 614, optimizable leaf instances 624, 628, and a synchronous element 626. The synchronous element 626 has an input port 632 and an output port 634. To determine whether the partition 600 includes a first optimizable leaf instance that is configured to drive a second optimizable leaf instance, the transitive fan-in of the partition output port 612 (e.g., a timing endpoint) may be traversed (e.g., including a timing path from the partition input port 602 through the optimizable leaf instance 628 to the partition output port 612 and a timing path from the output port 634 of the synchronous element 626 through the optimizable leaf instance 628 to the partition output port 612), in which no optimizable leaf instance that is configured to drive another optimizable leaf instance is identified. Then, the transitive fan-in of the partition output port 614 may be traversed (e.g., including a timing path from the output port 634 of the synchronous element 626 to the partition output port 614), in which no optimizable leaf instance that is configured to drive another optimizable leaf instance is identified. Then, the transitive fan-in of the input port 632 of the synchronous element 626 (e.g., a timing endpoint) may be traversed (e.g., including a timing path from the partition input port 604 through the optimizable leaf instance 624 to the input port 632 of the synchronous element 626 and a timing path from the partition input port 606 through the optimizable leaf instance 624 to the input port 632 of the synchronous element 626), in which no optimizable leaf instance that is configured to drive another optimizable leaf instance is identified. Hence, the partition 600 may be marked for exclusion from analysis in a logic optimization technique per the method 400 of FIG. 4.

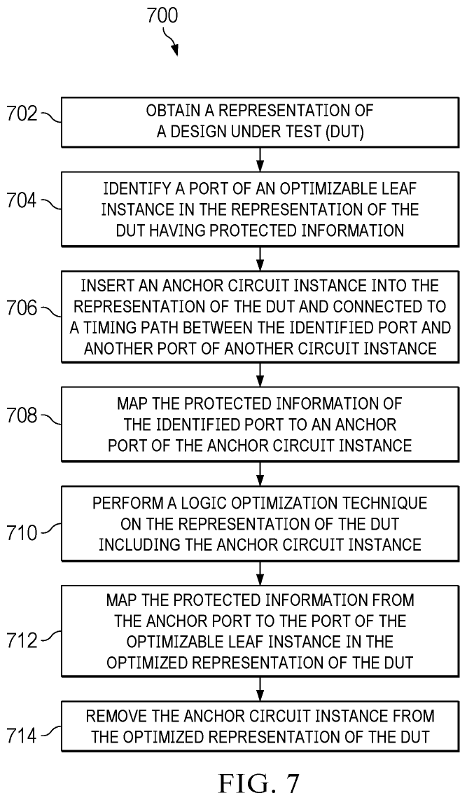

FIG. 7 is a flowchart of a method 700 for maintaining protected information in a representation of a DUT according to some examples. At 702, a representation of a DUT is obtained. In some examples, the representation of the DUT may be or include a netlist, such as an FPGA netlist, that is generated from a synthesis operation. Generally, the method 700 may traverse the representation of the DUT to identify ports that have protected information, although such traversal is not specifically illustrated.

At 704, a port of an optimizable leaf instance in the representation of the DUT that has protected information is identified. Protected information may be or include any information on the optimizable leaf instance that is to survive the logic optimization technique, such as false path information, waveform observation, or other information. At 706, an anchor circuit instance is inserted into the representation of the DUT and connected to a timing path between the identified port of the optimizable leaf instance and another port of another circuit instance. The anchor circuit instance may be any circuit instances that maintains the logical functionality in the timing path(s) in which the anchor circuit instance is inserted. For example, the anchor circuit instance may be a buffer circuit. At 708, the protected information of the identified port is mapped to an anchor port of the anchor circuit instance. The mapping may include changing information identifying, in the representation of the DUT, the identified port of the optimizable leaf instance to the port of the anchor instance to which the protected information is mapped or may include changing parameters of a netlist from the identified port of the optimizable leaf instance to specify (e.g., in HDL code) the port of the anchor instance.

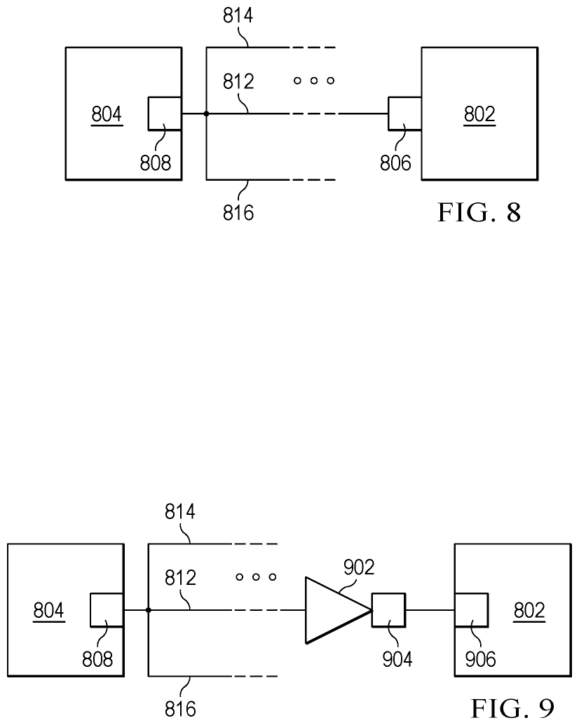

The method for connecting the anchor circuit instance to the timing path and determining which port of the anchor circuit instance is the anchor port may depend on whether the identified port is an input port or an output port of the optimizable leaf instance and/or the type of information that is the protected information. FIGS. 8, 9, 10, 11, and 12 illustrate examples of how an anchor circuit instance may be inserted and which port of the anchor circuit instance may be the anchor port according to some examples.

FIG. 8 shows an optimizable leaf instance 802 and a circuit instance 804 in a representation of a DUT. The circuit instance 804 may be another optimizable leaf instance, a non-optimizable leaf instance (such as a synchronous element, like a flip-flop), or another circuit component. The optimizable leaf instance 802 includes an input port 806 that has protected information. A first timing path 812 is connected between an output port 808 of the circuit instance 804 and the input port 806 of the optimizable leaf instance 802. In the illustrated example of FIG. 8, the circuit instance 804 is a driver circuit, and the optimizable leaf instance 802 is a load circuit. The output port 808 of the circuit instance 804 is configured to output and drive a signal received at the input port 806 of the optimizable leaf instance 802 in the representation of the DUT. In the representation of the DUT, the output port 808 of the circuit instance 804 is electrically connected to the input port 806 of the optimizable leaf instance 802. A second timing path 814 and a third timing path 816 are shown connected to the output port 808 of the circuit instance 804, although subsequent circuit instances along those timing paths 814, 816 are not shown to avoid obscuring aspects described herein. Although the timing paths 812, 814, 816 are described singularly, each of the timing paths 812, 814, 816 may include or represent one or multiple timing paths.

With the input port 806 being identified as the port having protected information at 704 of the method 700, an anchor circuit instance 902 (e.g., a buffer circuit) is inserted connected to the first timing path 812 at 706 of the method 700 and as shown in FIG. 9. The protected information of the input port 806 is mapped to the output port 904 of the anchor circuit instance 902 at 708 of the method 700.

As shown in FIG. 9, the anchor circuit instance 902 is inserted in the first timing path 812 between the output port 808 of the circuit instance 804 and the input port 906 (e.g., without the protected information) of the optimizable leaf instance 802. An input port of the anchor circuit instance 902 is electrically connected to the output port 808 of the circuit instance 804, and the output port 904 of the anchor circuit instance 902 is electrically connected to the input port 906 of the optimizable leaf instance 802.

Since the port having the protected information (e.g., the input port 806) is an input port, if the output port 808 of the circuit instance 804 is electrically connected to other circuit instances, such as illustrated by timing paths 814, 816, the anchor circuit instance 902 is inserted downstream from the branch(es) to the other load circuit instances. Hence, as illustrated in FIG. 9, the anchor circuit instance 902 is not connected in the timing paths 814, 816, although the input port of the anchor circuit instance 902 is electrically connected to the timing paths 814, 816 by being electrically connected to the output port 808 of the circuit instance 804.

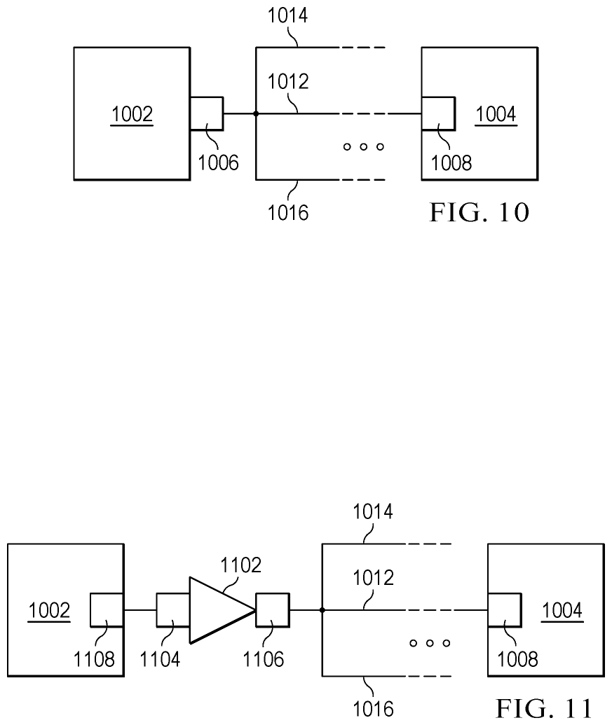

FIG. 10 shows an optimizable leaf instance 1002 and a circuit instance 1004 in a representation of a DUT. The circuit instance 1004 may be another optimizable leaf instance, a non-optimizable leaf instance (such as a synchronous element, like a flip-flop), or another circuit component. The optimizable leaf instance 1002 includes an output port 1006 that has protected information. A first timing path 1012 is connected between the output port 1006 of the optimizable leaf instance 1002 and an input port 1008 of the circuit instance 1004. In the illustrated example of FIG. 10, the optimizable leaf instance 1002 is a driver circuit, and the circuit instance 1004 is a load circuit. The output port 1006 of the optimizable leaf instance 1002 is configured to output and drive a signal received at the input port 1008 of the circuit instance 1004 in the representation of the DUT. In the representation of the DUT, the output port 1006 of the optimizable leaf instance 1002 is electrically connected to the input port 1008 of the circuit instance 1004. A second timing path 1014 and a third timing path 1016 are shown connected to the output port 1006 of the optimizable leaf instance 1002, although subsequent circuit instances along those timing paths 1014, 1016 are not shown to avoid obscuring aspects described herein. Although the timing paths 1012, 1014, 1016 are described singularly, each of the timing paths 1012, 1014, 1016 may include or represent one or multiple timing paths.

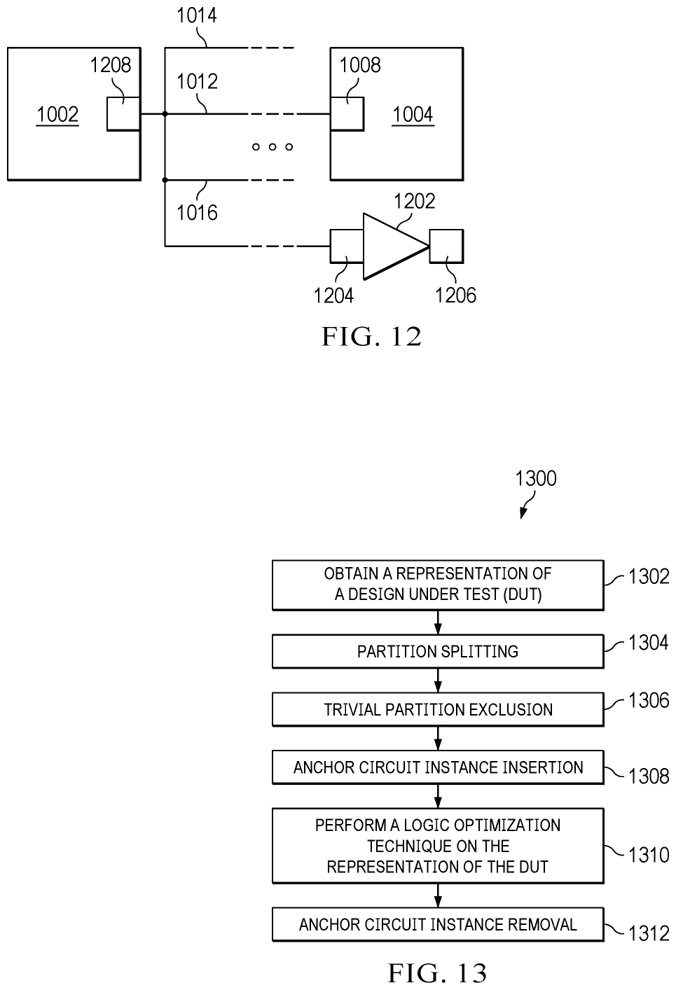

With the output port 1006 being identified as the port having protected information at 704 of the method 700, an anchor circuit instance 1102, 1202 (e.g., a buffer circuit) is inserted connected to the first timing path 1012 at 706 of the method 700 and as shown in FIGS. 11 and 12, respectively. The protected information of the output port 1006 is mapped to the input port 1104 and/or output port 1106 of the anchor circuit instance 1102 as shown in FIG. 11 or the input port 1204 and/or the output port 1206 of the anchor circuit instance 1202 as shown in FIG. 12 at 708 of the method 700. The protected information may be mapped to one of the input port 1104, 1204 or the output port 1106, 1206 in some examples. In some examples, some of the protected information may be mapped to the input port 1104, 1204, while other protected information may be mapped to the output port 1106, 1206.

As shown in FIG. 11, the anchor circuit instance 1102 is inserted in the first timing path 1012 between the output port 1108 (e.g., without the protected information) of the optimizable leaf instance 1002 and the input port 1008 of the circuit instance 1004. The input port 1104 of the anchor circuit instance 1102 is electrically connected to the output port 1108 of the optimizable leaf instance 1002, and the output port 1106 of the anchor circuit instance 1102 is electrically connected to the input port 1008 of the circuit instance 1004 and respective input ports of circuit instances in other timing paths 1014, 1016.

Since the port having the protected information (e.g., the output port 1006) is an output port, if the output port 1006 of the optimizable leaf instance 1002 is electrically connected to other circuit instances, such as illustrated by timing paths 1014, 1016, the anchor circuit instance 1102 is inserted upstream from the branch(es) to the other load circuit instances. Hence, as illustrated in FIG. 11, the anchor circuit instance 1102 is connected in each timing path 1012, 1014, 1016.

As shown in FIG. 12, the anchor circuit instance 1202 is inserted connected to the first timing path 1012 between the output port 1208 (e.g., without the protected information) of the optimizable leaf instance 1002 and the input port 1008 of the circuit instance 1004. The input port 1204 of the anchor circuit instance 1202 is electrically connected to the output port 1208 of the optimizable leaf instance 1002, and the output port 1206 of the anchor circuit instance 1202 may remain electrically floating.

Since the port having the protected information (e.g., the output port 1006) is an output port, if the output port 1006 of the optimizable leaf instance 1002 is electrically connected to other circuit instances, such as illustrated by timing paths 1014, 1016, the anchor circuit instance 1202 may be connected to the output port 1208 of the optimizable leaf instance 1002 via any timing path 1012, 1014, 1016 since the electrical potential (e.g., voltage) on the timing paths 1012, 1014, 1016 is the same. Hence, as illustrated in FIG. 12, the anchor circuit instance 1202 is connected to the timing paths 1012, 1014, 1016.

If the protected information includes false path information, the anchor circuit instance is inserted serially in the timing path(s) connected to the port of the optimizable leaf instance having the protected information, as shown by FIGS. 9 and 11. A false path may be a path that topologically exists in the DUT but is not functional and/or does not need to be timed. As an example, false path information could be marked on a timing arc including a pair of driver-reader ports on a same net, which specifies that the timing arc is part of a false path. To retain false path information, the connection from the driver port to the reader port is to be preserved. By inserting an anchor instance between the driver (output) port and the reader (input) port, the connection between the ports may be restored after logic optimization. If the port having the protected information is an input port, like in FIG. 8, the anchor circuit instance is inserted serially in the timing path(s) connected to that input port, which may be downstream from any branch for another timing path that may be connected to an output port of a circuit instance that is connected to the input port of the optimizable leaf instance. If the port having the protected information is an output port, like in FIG. 10, the anchor circuit instance is inserted serially in the timing path(s) connected to that output port, which may be upstream from any branch between timing paths that may be connected to that output port.

If the protected information includes waveform observation point information, the anchor circuit instance may be inserted in parallel with the timing path(s) connected to the port of the optimizable leaf instance having the protected information, as shown by FIG. 12. A waveform observation point includes where a signal may be preserved and may be used for debugging in later steps. The signal may be lost after logic optimization if the signal is an intermediate signal without one-to-one mapping before and after logic optimization. In some examples, a port having waveform observation point information may be treated as a primary output that will be preserved after logic optimization. Since the waveform being observed at a port may be the same along any timing path connected to that port, more freedom in inserting the anchor circuit instance may be obtained, and the anchor circuit instance may be inserted in parallel.

Referring back to FIG. 7, at 710, a logic optimization technique is performed on the representation of the DUT (or partition(s) thereof) including the anchor circuit instance. During the logic optimization technique, the anchor circuit instance is treated like a black box that is not subject to optimization, while the optimizable leaf instance may be exposed to the logic optimization technique and may be optimized. The logic optimization technique may be or include logic rewriting, logic rebalancing, logic refactoring, or the like. The logic optimization technique may produce an optimized representation of the DUT (or partition(s) thereof) including the anchor circuit instance. The optimized representation of the DUT may be or include a netlist, such as an FPGA netlist.

At 712, the protected information is mapped from the anchor port to the port of the optimizable leaf instance in the optimized representation of the DUT. The mapping may include changing information identifying, in the representation of the DUT, the port of the anchor instance back to the identified port of the optimizable leaf instance or may include changing parameters of a netlist from the port of the anchor instance to specify (e.g., in HDL code) the identified port of the optimizable leaf instance. At 714, the anchor circuit instance is removed from the optimized representation of the DUT. Removing the anchor circuit instance may be treated by, e.g., making the output port of the anchor circuit instance the same net as the input port of the anchor circuit instance (which may effectively short circuit the anchor circuit instance to thereby restore any timing path without the anchor circuit instance).

By inserting the anchor circuit instance as described, protected information may be anchored (e.g., maintained) in the representation of the DUT during the logic optimization technique while exposing the optimizable leaf instance to the logic optimization technique. Without inserting the anchor circuit instance, the optimizable leaf instance having the port with protected information might be treated as a black box that is not subject to optimization by the logic optimization technique. The optimizable leaf instance may be treated in this way due to the result of the logic optimization technique not necessarily having a one-to-one mapping with the representation of the DUT prior to the logic optimization technique, which may result in loss of the protected information. The anchor circuit instance permits a port and/or timing path to be maintained with a one-to-one mapping in the optimized representation of the DUT while exposing the optimizable leaf instance to the logic optimization technique. Exposing the optimizable leaf instance to the logic optimization technique may result in a better or more optimal optimized representation of the DUT.

FIG. 13 is a flowchart of a method 1300 for processing a DUT for mapping to an emulation and/or prototyping system according to some examples. The method 1300, as shown, includes operations of the methods 200, 400, 700 of FIGS. 2, 4, and 7. Other examples may include any combination or permutation of operations of the methods 200, 400, 700, including omitting operations of any one of the methods 200, 400, 700.

At 1302, a representation of a DUT is obtained, like in 202, 402, 702 of FIGS. 2, 4, and 7. At 1304, partition splitting is performed, which includes 204-220 of FIG. 2. At 1306, trivial partition exclusion is performed, which includes 404-412 of FIG. 4. When partition splitting is performed in 1304, the sub-partitions may be treated as partitions in 1306. At 1308, anchor circuit instance insertion is performed, which includes 704-708 of FIG. 7. At 1310, a logic optimization technique is performed on the representation of the DUT, like in 222, 414, 710 of FIGS. 2, 4, and 7. The logic optimization technique may be or include logic rewriting, logic rebalancing, logic refactoring, or the like. At 1312, anchor circuit instance removal is performed, which includes 712-714 of FIG. 7.

Implementing the method 1300 of FIG. 13 yielded improved results in some examples. In an example, runtime of resynthesis was improved by over 20% and emulator performance improved by 1% by splitting partitions as in 1304 compared to arbitrarily splitting partitions in half. Compared to resynthesis without splitting partitions, runtime of resynthesis improved by over 50% by splitting partitions as in 1304. Average compilation time overhead during resynthesis was reduced from over 70 minutes to 25 minutes. Longest compilation time overhead during resynthesis was reduced from over 30 minutes to less than 15 minutes.

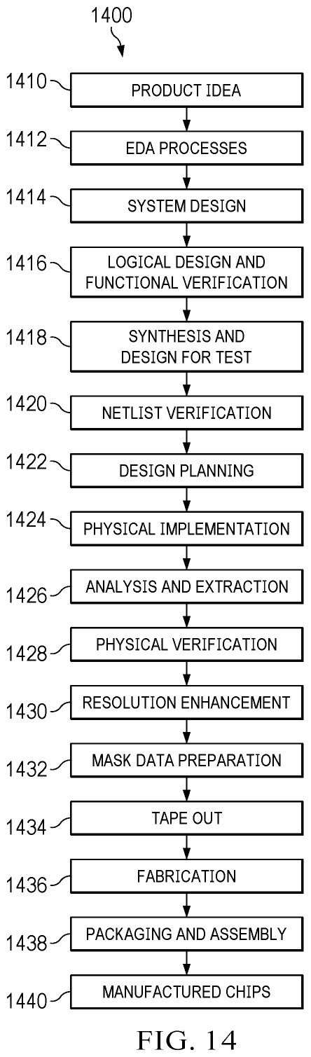

FIG. 14 illustrates an example set of processes 1400 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 1410 with information supplied by a designer, information which is transformed to create an article of manufacture that uses a set of EDA processes 1412. When the design is finalized, the design is taped-out 1434, which is when artwork (e.g., geometric patterns) for the integrated circuit is sent to a fabrication facility to manufacture the mask set, which is then used to manufacture the integrated circuit. After tape-out, a semiconductor die is fabricated 1436 and packaging and assembly processes 1438 are performed to produce the finished integrated circuit 1440.

Specifications for a circuit or electronic structure may range from low-level transistor material layouts to high-level description languages. A high-level of representation may be used to design circuits and systems, using a hardware description language (HDL) such as VHDL, Verilog, System Verilog, SystemC, MyHDL or Open Vera. The HDL description can be transformed to a logic-level register transfer level (RTL) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 14. The processes described by be enabled by EDA products (or EDA systems).

During system design 1414, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 1416, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 1418, HDL code is transformed to a netlist. In some embodiments, a netlist may be a graph structure where nodes of the graph structure represent components of a circuit and where the edges of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 1420, the netlist is checked for compliance with timing constraints and for correspondence with the HDL code. During design planning 1422, an overall floor plan for the integrated circuit is constructed and analyzed for timing and top-level routing.

During layout or physical implementation 1424, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR), a storage function (such as a flipflop or latch), etc. As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 1426, the circuit function is verified at the layout level, which permits refinement of the layout design. During physical verification 1428, the layout design is checked to ensure that manufacturing constraints are correct, such as DRC constraints, electrical constraints, lithographic constraints, and that circuitry function matches the HDL design specification. During resolution enhancement 1430, the geometry of the layout is transformed to improve how the circuit design is manufactured.

During tape-out, data is created to be used (after lithographic enhancements are applied if appropriate) for production of lithography masks. During mask data preparation 1432, the tape-out data is used to produce lithography masks that are used to produce finished integrated circuits.

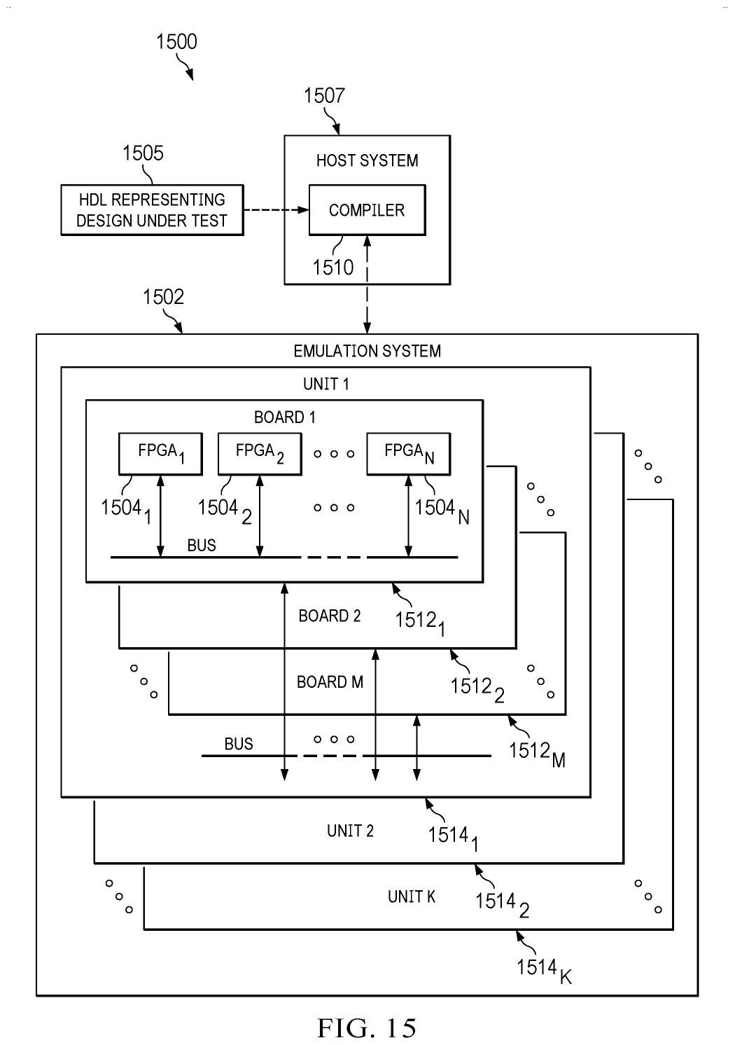

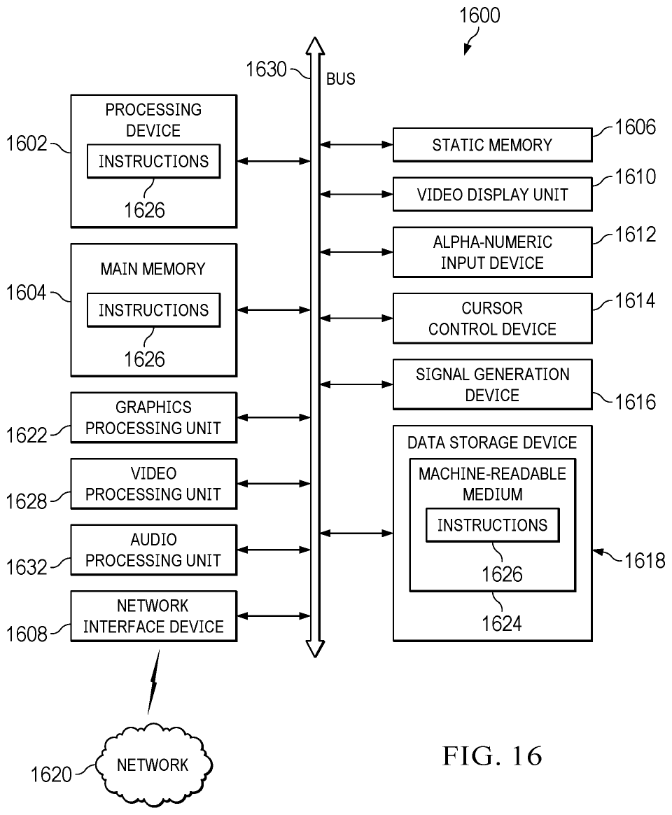

A storage subsystem of a computer system (such as computer system 1600 of FIG. 16, or host system 1507 of FIG. 15) may be used to store the programs and data structures that are used by some or all of the EDA products described herein, and products used for development of cells for the library and for physical and logical design that use the library.

FIG. 15 depicts a diagram of an example emulation environment 1500. An emulation environment 1500 may be configured to verify the functionality of the circuit design. The emulation environment 1500 may include a host system 1507 (e.g., a computer that is part of an EDA system) and an emulation system 1502 (e.g., a set of programmable devices such as Field Programmable Gate Arrays (FPGAs) or processors). The host system generates data and information by using a compiler 1510 to structure the emulation system to emulate a circuit design. A circuit design to be emulated is also referred to as a Design Under Test (DUT) where data and information from the emulation are used to verify the functionality of the DUT.

The host system 1507 may include one or more processors. In the embodiment where the host system includes multiple processors, the functions described herein as being performed by the host system can be distributed among the multiple processors. The host system 1507 may include a compiler 1510 to transform specifications written in a description language that represents a DUT and to produce data (e.g., binary data) and information that is used to structure the emulation system 1502 to emulate the DUT. The compiler 1510 can transform, change, restructure, add new functions to, and/or control the timing of the DUT.

The host system 1507 and emulation system 1502 exchange data and information using signals carried by an emulation connection. The connection can be, but is not limited to, one or more electrical cables such as cables with pin structures compatible with the Recommended Standard 232 (RS232) or universal serial bus (USB) protocols. The connection can be a wired communication medium or network such as a local area network or a wide area network such as the Internet. The connection can be a wireless communication medium or a network with one or more points of access using a wireless protocol such as BLUETOOTH or IEEE 802.11. The host system 1507 and emulation system 1502 can exchange data and information through a third device such as a network server.

The emulation system 1502 includes multiple FPGAs (or other modules) such as FPGAs 15041 and 15042 as well as additional FPGAs to 1504N. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 1502 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 15041-804N may be placed onto one or more boards 15121 and 15122 as well as additional boards through 1512M. Multiple boards can be placed into an emulation unit 15141. The boards within an emulation unit can be connected using the backplane of the emulation unit or any other types of connections. In addition, multiple emulation units (e.g., 15141 and 15142 through 1514K) can be connected to each other by cables or any other means to form a multi-emulation unit system.

For a DUT that is to be emulated, the host system 1507 transmits one or more bit files to the emulation system 1502. The bit files may specify a description of the DUT and may further specify partitions of the DUT created by the host system 1507 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 1507 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 1507 and/or the compiler 1510 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 1505 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 16 illustrates an example machine of a computer system 1600 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1600 includes a processing device 1602, a main memory 1604 (e.g., read-only memory (ROM), flash memory, dynamic random access memory (DRAM) such as synchronous DRAM (SDRAM), a static memory 1606 (e.g., flash memory, static random access memory (SRAM), etc.), and a data storage device 1618, which communicate with each other via a bus 1630.

Processing device 1602 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1602 may also be one or more special-purpose processing devices such as an application specific integrated circuit (ASIC), a field programmable gate array (FPGA), a digital signal processor (DSP), network processor, or the like. The processing device 1602 may be configured to execute instructions 1626 for performing the operations and steps described herein.

The computer system 1600 may further include a network interface device 1608 to communicate over the network 1620. The computer system 1600 also may include a video display unit 1610 (e.g., a liquid crystal display (LCD) or a cathode ray tube (CRT)), an alphanumeric input device 1612 (e.g., a keyboard), a cursor control device 1614 (e.g., a mouse), a graphics processing unit 1622, a signal generation device 1616 (e.g., a speaker), graphics processing unit 1622, video processing unit 1628, and audio processing unit 1632.

The data storage device 1618 may include a machine-readable storage medium 1624 (also known as a non-transitory computer-readable storage medium) on which is stored one or more sets of instructions 1626 or software embodying any one or more of the methodologies or functions described herein. The instructions 1626 may also reside, completely or at least partially, within the main memory 1604 and/or within the processing device 1602 during execution thereof by the computer system 1600, the main memory 1604 and the processing device 1602 also constituting machine-readable storage media.

In some implementations, the instructions 1626 include instructions to implement functionality corresponding to the present disclosure. While the machine-readable storage medium 1624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1602 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a non-transitory computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable storage medium having stored thereon instructions, which may be used to program a computer system (or other electronic devices) to perform a process according to the present disclosure. A machine-readable storage medium includes any mechanism for storing information in a form readable by a machine (e.g., a computer). For example, a machine-readable (e.g., a computer-readable) storage medium includes a machine-readable (e.g., a computer-readable) storage medium such as a read only memory (ROM), random access memory (RAM), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A non-transitory computer-readable storage medium comprising stored instructions, which when executed by one or more processors, cause the one or more processors to:
obtain a representation of a design under test (DUT), the representation of the DUT including optimizable leaf instances and timing paths between respective timing startpoints and timing endpoints; and
split the representation of the DUT into multiple partitions based on respective slacks of the timing endpoints, each partition of the multiple partitions including one or more timing endpoints of the timing endpoints and a transitive fan-in including one or more optimizable leaf instances along one or more timing paths of the timing paths that terminate at the respective one or more timing endpoints.

2. The non-transitory computer-readable storage medium of claim 1, wherein the instructions, which when executed by the one or more processors, further cause the one or more processors to: perform logic optimization on at least one of the multiple partitions.

3. The non-transitory computer-readable storage medium of claim 1, wherein the instructions, which when executed by the one or more processors, cause the one or more processors to split the representation of the DUT into the multiple partitions based on the respective slacks of the timing endpoints further cause the one or more processors to:
iteratively until each timing endpoint of the timing endpoints having a transitive fan-in including optimizable leaf instances has been collected in a partition:
create a partition; and
iteratively until a minimum target number of optimizable leaf instances has been collected in the respective partition, collect, in the respective partition, optimizable leaf instances in the transitive fan-in of the timing endpoint that has a lowest slack that has not been collected in any partition.

4. The non-transitory computer-readable storage medium of claim 1, wherein the instructions, which when executed by the one or more processors, further cause the one or more processors to: flatten the representation of the DUT to a level of the optimizable leaf instances.

5. The non-transitory computer-readable storage medium of claim 1, wherein the instructions, which when executed by the one or more processors, further cause the one or more processors to:
determine, for each partition of the multiple partitions, whether the respective partition includes a first optimizable leaf instance that drives a second optimizable leaf instance; and
mark the respective partition for logic optimization based on a determination that the respective partition includes the first optimizable leaf instance that drives the second optimizable leaf instance.

6. The non-transitory computer-readable storage medium of claim 5, wherein the instructions, which when executed by the one or more processors, further cause the one or more processors to:
insert an anchor circuit instance into a partition of the multiple partitions and connected to a timing path of the timing paths, the timing path being between a first port of an optimizable leaf instance of the optimizable leaf instances and a second port of a circuit instance, the first port including protected information; and
map the protected information of the first port to an anchor port of the anchor circuit instance.

7. The non-transitory computer-readable storage medium of claim 1, wherein the instructions, which when executed by the one or more processors, further cause the one or more processors to:
insert an anchor circuit instance into a partition of the multiple partitions and connected to a timing path of the timing paths, the timing path being between a first port of an optimizable leaf instance of the optimizable leaf instances and a second port of a circuit instance, the first port including protected information; and
map the protected information of the first port to an anchor port of the anchor circuit instance.

8. A system comprising:
a memory storing instructions; and
a processing device coupled with the memory and to execute the instructions, the instructions when executed cause the processing device to:
obtain a representation of a design under test (DUT), the representation of the DUT including multiple partitions;
determine, for each partition of the multiple partitions, whether the respective partition includes a first optimizable leaf instance that drives a second optimizable leaf instance; and
mark the respective partition for logic optimization based on a determination that the respective partition includes a first optimizable leaf instance that drives a second optimizable leaf instance.

9. The system of claim 8, wherein the instructions when executed further cause the processing device to perform the logic optimization on the partitions marked for the logic optimization, wherein the logic optimization excludes another partition based on another determination that the other partition does not include a first optimizable leaf instance that drives a second optimizable leaf instance.

10. The system of claim 8, wherein the instructions when executed further cause the processing device to:
insert an anchor circuit instance into a partition that is marked for inclusion to be analyzed in the logic optimization technique and connected to a timing path between a first port of an optimizable leaf instance and a second port of a circuit instance, the first port including protected information; and
map the protected information of the first port to an anchor port of the anchor circuit instance.

11. A method, comprising:
obtaining a representation of a design under test (DUT);
inserting, by a processing device, an anchor circuit instance into the representation of the DUT and connected to a timing path between a first port of an optimizable leaf instance and a second port of a circuit instance, the first port including protected information; and
mapping the protected information of the first port to an anchor port of the anchor circuit instance.

12. The method of claim 11, further comprising:
performing a logic optimization on the representation of the DUT including the anchor circuit instance; and
mapping the protected information from the anchor port of the anchor circuit instance to the first port in the optimized representation of the DUT.

13. The method of claim 11, wherein inserting the anchor circuit instance comprises inserting and connecting the anchor circuit instance serially in the timing path.

14. The method of claim 13, wherein the protected information includes false path information.

15. The method of claim 11, wherein inserting the anchor circuit instance comprises inserting and connecting the anchor circuit instance in parallel with the timing path.

16. The method of claim 15, wherein the protected information includes waveform observation point information.

17. The method of claim 11, wherein:
inserting the anchor circuit instance includes inserting the anchor circuit instance in the timing path from an output port of the circuit instance to an input port of the optimizable leaf instance;
the input port of the optimizable leaf instance is the first port;
the output port of the circuit instance is the second port; and
the anchor port is an output port of the anchor circuit instance.

18. The method of claim 11, wherein:
inserting the anchor circuit instance includes inserting the anchor circuit instance in each timing path from an output port of the optimizable leaf instance, the timing path being from the output port of the optimizable leaf instance to an input port of the circuit instance;
the output port of the optimizable leaf instance is the first port; and
the input port of the circuit instance is the second port.

19. The method of claim 11, wherein:
inserting the anchor circuit instance includes inserting the anchor circuit instance connected to the timing path from an output port of the optimizable leaf instance to an input port of the circuit instance, an input port of the anchor circuit instance being connected to the timing path;
the output port of the optimizable leaf instance is the first port;
the input port of the circuit instance is the second port; and
an output port of the anchor circuit instance is floating.

20. The method of claim 11, wherein the anchor circuit instance includes a buffer circuit.
